(19) United States
(12) Patent Application Publication
(10) Pub. No.: US 2005/0045177 A1
(43) Pub. Date: Mar. 3, 2005

(54) Method and system for treating sleeping disorders

(76) Inventor: Jeff Lacour, South Daytona Beach, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/929,879

(22) Filed: Aug. 30, 2004

Related U.S. Application Data
(60) Provisional application No. 60/498,714, filed on Aug. 29, 2003.

(51) Int. Cl. B60T 8/24; A61G 10/00

(52) U.S. Cl. 128/202.12

(57) ABSTRACT

A method for treating sleeping disorders comprising injecting air into a sealed chamber while a patient sleeps in order to increase the pressure within the chamber to about 0.01 inches of water column above ambient atmospheric pressure.

This application claims priority of Provisional Patent Application Ser. No. 60/498,714, filed on Aug. 29, 2003.

### BACKGROUND OF THE INVENTION

This invention relates in general to methods or systems used to aid in the treatment of sleeping disorders.

Sleeping disorders are related, in part, to the stress exerted upon the body by gravity, which is approximately 15 pounds per square inch. The pressure applied by gravity may cause blood vessels or arteries to constrict, reducing the ability of organs to function as a result of blood supply thereto. The body will respond by causing the vessels to dilate to create a level of equilibrium between the outside pressure applied and that being exerted by the internal pressure of the body.

During sleep, an aging or poorly conditioned body may react to the force of gravity by implementing certain fail-safe mechanisms because other organs, including blood vessels and arteries, are not capable of appropriately responding. One such mechanism is deeper breathing/snoring. Another fail-safe mechanism is sudden consciousness (waking) or restlessness (insomnia) implemented for the purpose of recruiting a stronger response from the organs than is typical during sleep.

The present invention utilizes a sleeping chamber in which air is introduced into a chamber to increase the pressure within the chamber as compared to ambient atmospheric pressure. The present invention is similar in some respects to a hyperbaric chamber, which utilizes increased pressure ranges to treat a variety of illnesses. However, hyperbaric chambers have not been used to treat sleeping disorders. In addition, hyperbaric chambers typically require introduction of compressed air and oxygen under pressure.

### SUMMARY OF THE INVENTION

The present invention for a method comprises introducing ambient air into an enclosed chamber in which a person may sleep and increasing the pressure within the chamber above ambient atmospheric pressure. The term ambient atmosphere as used in this disclosure means the atmosphere outside the chamber. A chamber in which a mattress is supported may implement the method. An air supply source is in fluid communication with the interior of the chamber, for introducing ambient air that is preferably not under pressure or compressed, into the chamber. The flow of air into the chamber increases the pressure to a predetermined pressure range above atmospheric pressure with respect to the air ambient to the chamber. The pressure is preferably increased from about 0.1 inches water column to about 1 inch of water.

### BRIEF DESCRIPTION OF THE DRAWINGS

FIG. 1 is a perspective view of the system.

FIG. 2 is front elevational view of the system.

FIG. 3 is a partial sectional view of the interior of the system.

### DETAILED DESCRIPTION OF THE INVENTION

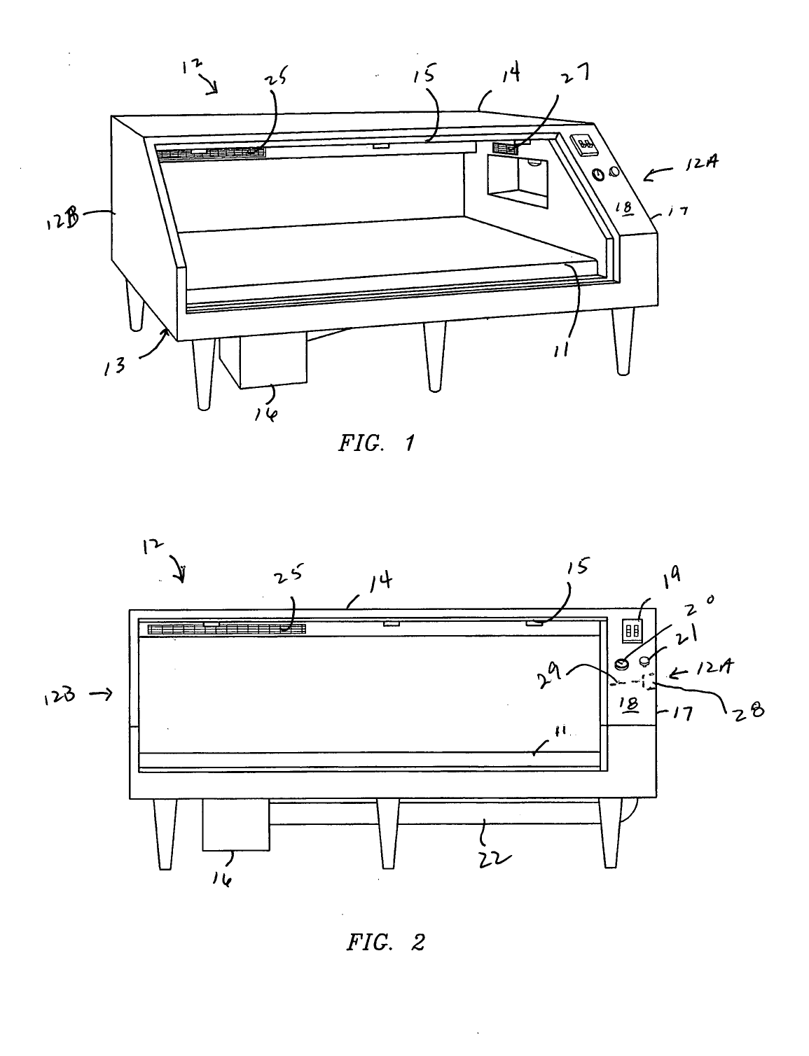

The system for treatment of sleeping disorders generally includes a mattress that is supported and enclosed within a sealed chamber. An exemplary embodiment of the system is shown in FIGS. 1, 2 and 3. The system comprises the mattress 11, which should be sufficiently large to accommodate a human body. A chamber 12 includes a substantially planar bottom 13 that supports the mattress 11. A top portion 14 is secured in air-sealed relation to the bottom 13. The top portion 14 includes a door 15 that is retractable from an open to closed position, as shown in FIGS. 1 and 2, so a user may climb into, and out of, the chamber 11. The door 15 shown in the FIGS. 1 through 3 is a panel that slides on a tracks between a closed an open position. The door 15 is in a retracted open position to illustrate the interior of the chamber.

The chamber 12 may be constructed of sufficiently durable and light material, including wood, aluminum or plastic, for example. The chamber 12 preferably includes one or more transparent panels. The transparent panels may be constructed of a durable transparent material such as glass, Plexiglas or acrylic. Connections between different panels or parts of the chamber 12 should be sufficiently sealed to prevent air leakage into and from the chamber 12 in order to maintain a predetermined pressure or range of pressures within the chamber 12, above ambient atmospheric pressure. In as much as the door 15 may be opened or closed, sealing strips (not shown) along the door edges may seal the chamber 12. The sealing strips may include typical sealing material comprising plastic, rubber or vinyl.

An air supply system 16 is mounted to the chamber 12 to supply a flow of air into the chamber 11 to increase the air pressure within the chamber 12 to about or within a predetermined range slightly above atmospheric pressure with respect to the chamber. For example the pressure within the chamber 12 may be increased by approximately 0.1 inches water column to one inch water column above ambient atmospheric pressure. The air supply system 16 may include a blower that runs at 3010 rpms and discharges air at a rate of 25 cubic feet per minute for a 90 cubic foot chamber 12.

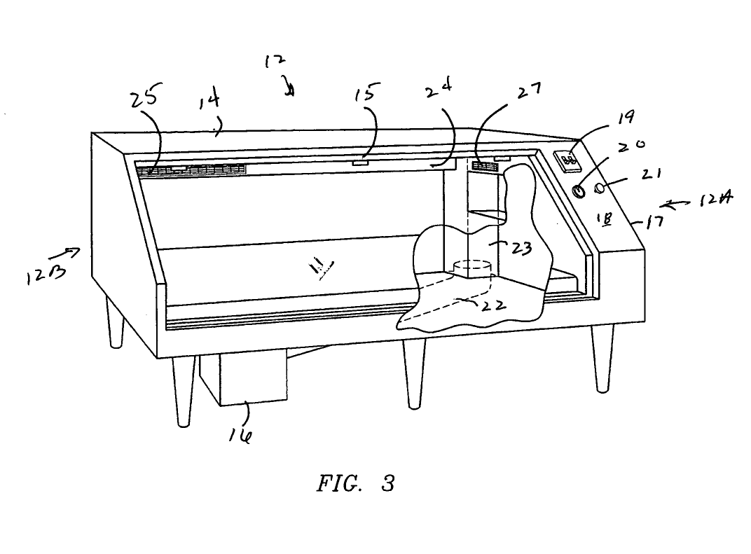

With respect to FIG. 3, the fluid communication of air supply source 16 with the interior of the chamber 12 is shown in more detail. The chamber has a head end 12A and a foot end 12B. The head 12A of the chamber 12 includes a case 17 having an instrument panel 18 including one or more switches 19 for activating and deactivating the air supply source 16, a pressure gauge 20 and control dial 21 for controlling the pressure within the chamber 12.

A duct 22 connects the air supply source 16 to the interior of the case 17. More specifically, the duct 22 is in fluid communication with a first conduit 23 vertically disposed within the case. The first conduit 23 is in fluid communication with a second conduit 24 that is horizontally disposed within the chamber 11. A vent 25, disposed toward the foot 12B of the chamber 12 allows for the introduction of airflow from the air supply source 16 into the chamber 12.

A pressure gauge sensor 20 and control dial 21 are used to regulate the pressure increase within the chamber 12. The gauge 20 detects and displays the pressure increase within the interior of the chamber 12. The invention is not limited to any particular pressure gauges other than the gauge must be sensitive enough to detect slight changes in pressure within the chamber. Those skilled in the art will appreciate and understand which type sensors and gauges are available and work. The gauge 20 may include a mechanical or digital reading in acceptable pressure measurements i.e., inches water column, pounds per square inch or atmospheres.

A second vent 27 is mounted in the chamber 12 toward the head 12A of the chamber 12 in order to exhaust air from the interior of the chamber 12. In this manner, air introduced into the chamber 12 through the first vent 25 flows through the chamber 12 and may be exhausted from the chamber through the second vent 27. Although, air is discharged through the second vent 27, the air supply source 16 introduces air into the chamber 12 at a sufficient rate and volume to maintain the desired pressure increase.

The control dial 21 is operatively connected to at least one relief valve 28 mounted to the chamber 12 to release air from the interior of the chamber continuously or intermittently, at such a rate to maintain the pressure increase desired. The relief valve 28 may be a 1½-inch variable relief valve that is set to release internal pressure to maintain the internal pressure chamber within a desired or predetermined range of pressure increase. Air is preferably directed to line 29, to which the relief valve 28 is connected.

In use, a patient will activate the air supply source 16 using switches 19. Once the desired pressure increase is maintained using the gauge 20 and control dial 21, the patient opens the door 15, enters the chamber 12 and closes door 15. A slight pressure drop will occur when the door 15 is opened, but the pressure will quickly increase to the desired level after the door is shut. When the patient awaits and exits the chamber 12, the air supply source is deactivated. The setting on the control dial 21 should be maintained so minimal, if any, adjustment is required for later use. The amount of pressure increase may depend on a particular individual using the system. It is anticipated, however, the optimal pressure increase for most individuals will be in the range of about 0.1 inches water column to about one inch water column, or any equivalent measurement of air pressure in pounds per square inch or atmospheres for example.

While the invention has been described in what is presently considered to be a preferred embodiment, many variations and modifications will become apparent to those skilled in the art. Accordingly, it is intended that the invention not be limited to the specific illustrative embodiment, but be interpreted within the full spirit and scope of the appended claims.

1. A system for the treatment of sleeping disorders, comprising:
(a) a chamber having an interior sealed from atmospheric pressure conditions;
(b) a mattress within the chamber for comfortably supporting a patient; and
(c) means, in fluid communication with the interior of the chamber, for injecting air, that is not pressurized or compressed, into the interior of the chamber to increase pressure to a predetermined level that is greater than the atmospheric pressure.

2. The system of claim 1 wherein the pressure is increased by approximately 0.1 inches water column to one inch water column above ambient atmospheric pressure.

3. The system of claim 1 further comprising a first vent positioned toward a foot end of the chamber for introduction of air into the chamber and a second vent positioned toward a head end of the chamber for discharging air from the chamber.

4. The system of claim 1 further comprising a relief valve to exhaust air from the chamber to maintain the increase of the pressure at the predetermined level.

5. A method for the treatment of sleeping disorders, comprising:
(a) enclosing a patient within a chamber; and,
(b) increasing the air pressure within the chamber to a predetermined level above ambient atmospheric pressure.

6. The method of claim 5 wherein the step of increasing the pressure within the chamber includes increasing the pressure in the range of about 0.1 inches water column to one inch water column above ambient atmospheric pressure.

7. A method for treatment of sleeping disorders, comprising the step of injecting ambient air into an enclosed chamber while a patient is sleeping, wherein the air is not compressed or under pressure prior to introduction into the chamber, to increase the pressure within the chamber to a predetermined pressure level above ambient atmospheric pressure.

8. The method of claim 5 wherein the pressure within the chamber is increased to about 0.1 inches water column to about one inch water column above ambient atmospheric pressure.

9. The method of claim 5 further including the step of releasing air from the chamber to maintain the pressure in the chamber at the predetermined level.
